(19) United States
(12) Patent Application Publication
(10) Pub. No.: US 2017/0198758 A1
(43) Pub. Date: Jul. 13, 2017

(54) WEDGE CLUTCH WITH MUTUALLY SUPPORTING WEDGE PLATES

(71) Applicant: Schaeffler Technologies AG & Co. KG, Herzogenaurach (DE)

(72) Inventor: Marion Jack Ince, Mt. Holly, NC (US)

(21) Appl. No.: 14/994,505

(22) Filed: Jan. 13, 2016

(51) Int. Cl. F16D 15/00; F16D 25/00; F16D 28/00; F16D 23/12

(52) U.S. Cl. CPC F16D 15/00; F16D 23/12; F16D 25/00; F16D 28/00

(57) ABSTRACT

A wedge clutch, including: a first hub; a second hub; an outer ring located radially outward of the first and second hubs; a first wedge plate radially disposed between the first hub and the outer ring; a second wedge plate radially disposed between the second hub and the outer ring; and a displacement assembly arranged to: for a connect mode, axially displace the first and second hubs with respect to each other to non-rotatably connect the first and second hubs to the outer ring; and for a disconnect mode, axially displace the first and second hubs with respect to each other to enable rotation between the outer ring and the first and second hubs.

### TECHNICAL FIELD

Described herein is a wedge clutch with mutually supporting wedge plates. In particular, the wedge clutch includes two axially displaceable hubs with complimentarily sloping surfaces engaged with respective wedge plates. The wedge plates contacting each other during torque transmission by the wedge clutch. The contact eliminates deflection of the wedge plates.

### BACKGROUND

Wedge clutches using one or more wedge plates between an inner hub and an outer ring are known in the art. The wedge plates are typically made of a spring material to enable biasing of the wedge plates. Ideally, the full inner and outer circumferential surfaces of the wedge plates contact the inner hub and the outer ring, respectively, during torque transmission by the wedge clutches. However, compressive forces exerted on the wedge plates during torque transmission cause the wedge plates to deflect, which in turn causes portions of the inner and outer circumferential surfaces of the wedge plates to lift off the inner hub and the outer ring, respectively, causing point contact between the wedge plates and the inner hub and outer ring. The point contact can damage the inner hub and outer ring and reduces the contact area between the wedge plate and the inner hub and outer race. This reduction of contact area reduces the torque-carrying capacity of the wedge clutch.

### SUMMARY

According to aspects illustrated herein, there is provided a wedge clutch, including: a first hub; a second hub; an outer ring located radially outward of the first and second hubs; a first wedge plate radially disposed between the first hub and the outer ring; a second wedge plate radially disposed between the second hub and the outer ring; and a displacement assembly arranged to: for a connect mode, axially displace the first and second hubs with respect to each other to non-rotatably connect the first and second hubs to the outer ring; and for a disconnect mode, axially displace the first and second hubs with respect to each other to enable rotation between the outer ring and the first and second hubs.

According to aspects illustrated herein, there is provided a wedge clutch, including: a first hub including a first surface sloping radially inward in a first axial direction; a second hub including a second surface sloping radially inward in a second axial direction opposite the first axial direction; an outer ring located radially outward of the first and second hubs; a first wedge plate radially disposed between the first hub and the outer ring and engaged with the first surface; a second wedge plate radially disposed between the second hub and the outer ring and engaged with the second surface; and a displacement assembly arranged to: for a connect mode, axially displace the first and second hubs with respect to each other to non-rotatably connect the first and second hubs to the outer ring; and for a disconnect mode, axially displace the first and second hubs with respect to each other to enable rotation between the outer ring and the first and second hubs.

According to aspects illustrated herein, there is provided a wedge clutch, including: a first hub; a second hub; an outer ring located radially outward of the first and second hubs; a first wedge plate radially disposed between the first hub and the outer ring and in contact with the first hub; a second wedge plate radially disposed between the second hub and the outer ring and in contact with the second hub; and, a displacement assembly including a first resilient element urging the first hub in a first axial direction, an actuator, a ball axially located between the first and second hubs, and a second resilient element urging the ball radially outward. For a connect mode: the first resilient element is arranged to displace the first hub in the first axial direction; the actuator is arranged to displace the second hub in a second axial direction opposite the first axial direction; and the first and second hubs are arranged to displace the first and second wedge plates, respectively, radially outward to non-rotatably connect the first and second hubs to the outer ring. For a disconnect mode: the actuator is arranged to displace the second hub in the first axial direction; the second resilient element is arranged to displace the first hub in the second axial direction; and the first and second wedges are arranged to displace radially inward to enable rotation between the outer ring and the first and second hubs.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a partial cross-sectional view of a wedge clutch with axially displaceable hubs during initiation of a connect mode;

FIG. 3 is a partial cross-sectional view of the wedge clutch in FIG. 2 upon completion of the connect mode;

FIG. 4 is a partial cross-sectional view of the wedge clutch shown in FIG. 2 in a disconnect mode;

FIG. 5 is a cross-sectional view of the front hub in FIG. 2, generally along line 5-5 in FIG. 2;

FIG. 6 is a cross-sectional view of the rear hub in FIG. 2, generally along line 6-6 in FIG. 2;

FIG. 7 is a front perspective view of the front wedge plate shown in FIG. 2; and,

FIG. 8 is a back perspective view of the rear wedge plate shown in FIG. 2.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

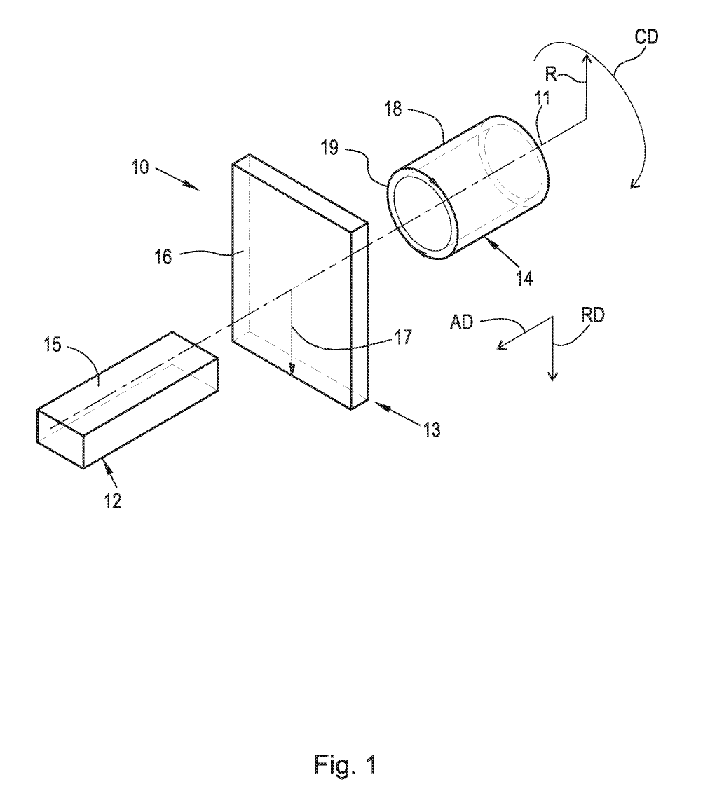

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

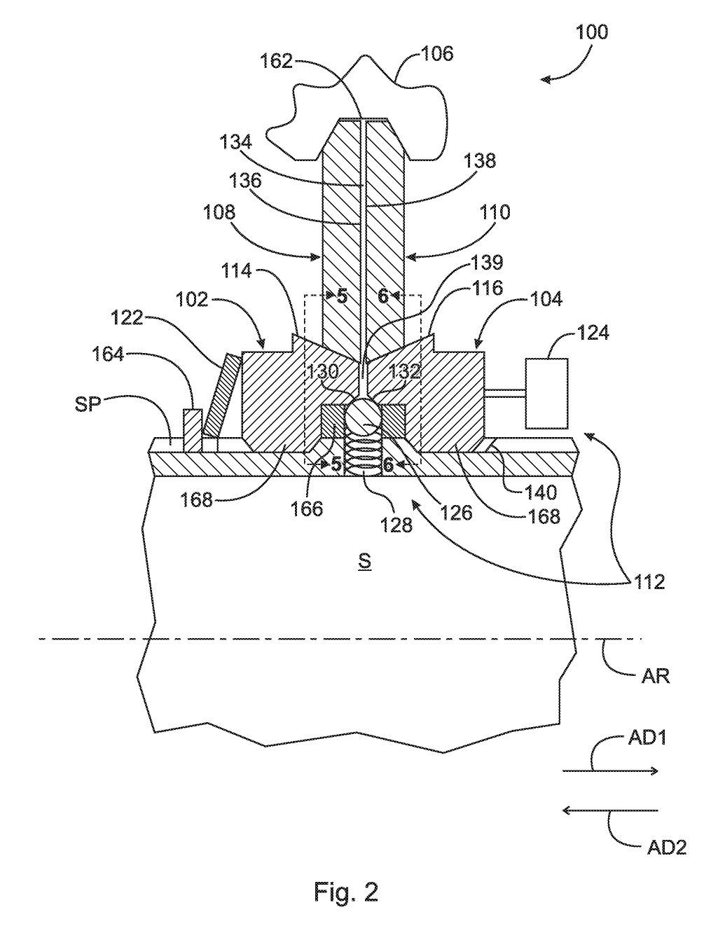

FIG. 2 is a partial cross-sectional view of wedge clutch 100 with axially displaceable hubs during initiation of a connect mode.

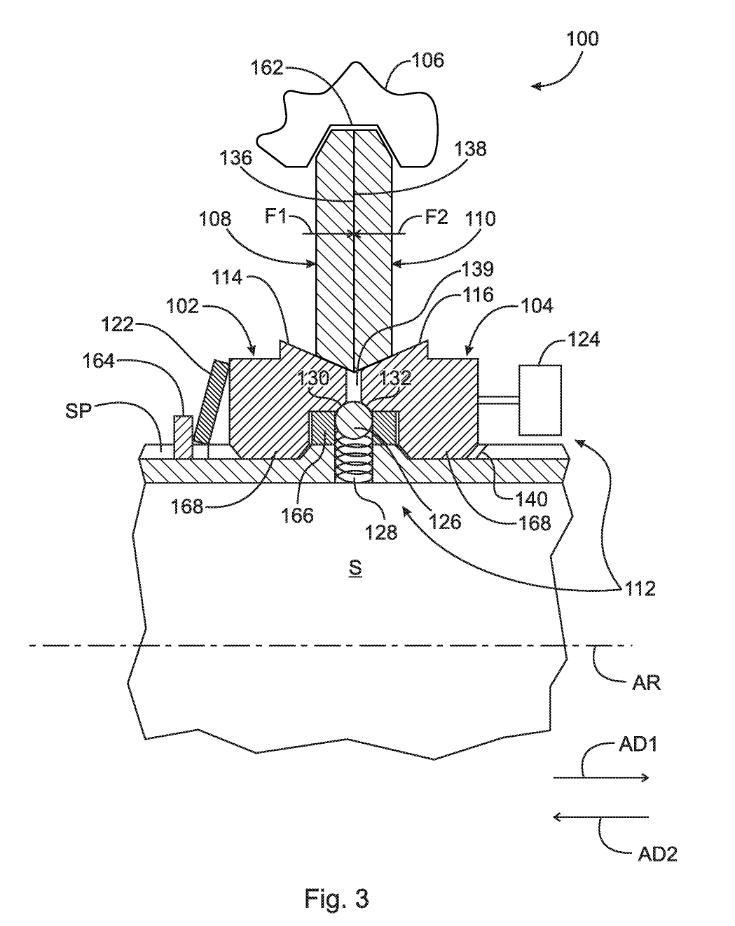

FIG. 3 is a partial cross-sectional view of wedge clutch 100 in FIG. 2 upon completion of the connect mode.

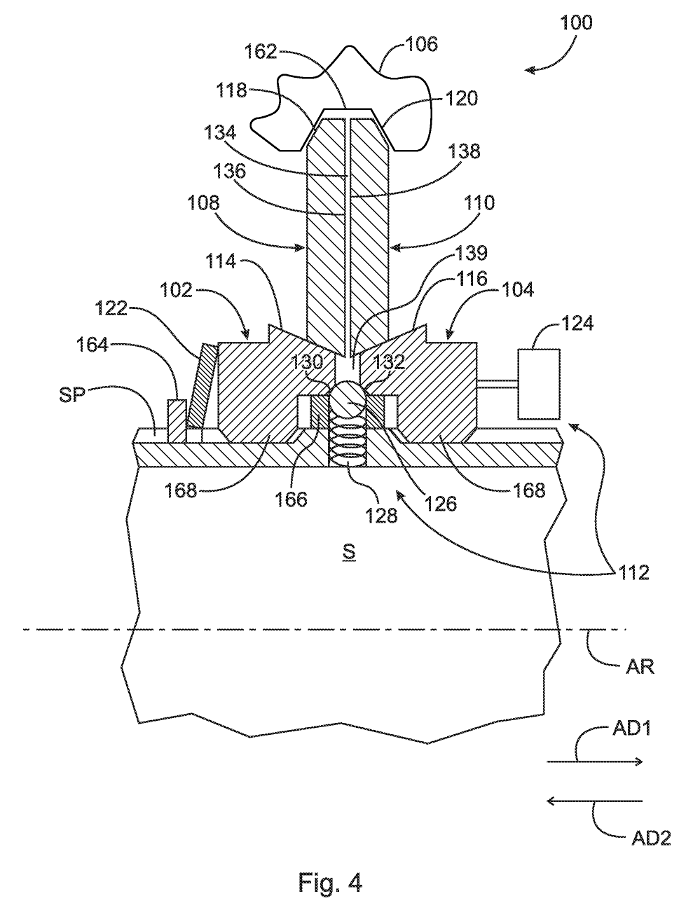

FIG. 4 is a partial cross-sectional view of wedge clutch 100 shown in FIG. 2 in a disconnect mode. The following should be viewed in light of FIGS. 2 through 4. Wedge clutch 100 includes: axis of rotation AR; hub 102; hub 104; outer ring 106 located radially outward of hubs 102 and 104; wedge plate 108; wedge plate 110; and displacement assembly 112. Wedge plate 108 is radially disposed between hub 102 and outer ring 106. Wedge plate 110 is radially disposed between hub 104 and outer ring 106. For the connect mode for clutch 100, displacement assembly 112 is arranged to axially displace hub 102 and hub 104 with respect to each other to non-rotatably connect hub 102 and hub 104 to outer ring 106. For a disconnect mode, displacement assembly 112 is arranged to axially displace hub 102 and hub 104 with respect to each other to enable rotation between outer ring 106 and hubs 102 and 104. By “non-rotatably connected” elements, we mean that: the elements are connected so that whenever one of the elements rotate, all the elements rotates; and relative rotation between the elements is not possible. Radial and/or axial movement of non-rotatably connected elements with respect to each other is possible, but not required.

In an example embodiment, for the connect mode, displacement assembly 112 is arranged to axially displace hub 102 and hub 104 toward each other. In an example embodiment, for the disconnect mode, displacement assembly 112 is arranged to axially displace hub 102 and hub 104 away from each other.

In an example embodiment: hub 102 includes surface 114 sloping in axial direction AD1 and engaged with wedge plate 108, for example, surface 114 is in contact with wedge plate 108; and, hub 104 includes surface 116 sloping in axial direction AD2, opposite AD1, and engaged with wedge plate 110, for example, surface 116 is in contact with wedge plate 110. In an example embodiment: surface 114 slopes radially inward toward hub 104; and surface 116 slopes radially inward toward hub 102.

In an example embodiment, wedge plate 108 and wedge plate 110 are biased such that wedge plate 108 and wedge plate 110 are urged into contact with hub 102 and hub 104, respectively, for example, with surfaces 114 and 116, respectively. For the disconnect mode: surfaces 114 and 116 are arranged to slide along wedge plate 108 and wedge plate 110, respectively; and, wedge plate 108 and wedge plate 110 are arranged to displace radially inward, for example, creating gap 118 between wedge plate 108 and outer ring 106 and creating gap 120 between wedge plate 110 and outer ring 106.

In an example embodiment, displacement assembly 112 includes: element 122 urging hub 102 in axial direction AD1; element 124; element 126 disposed between hub 102 and hub 104 in axial direction AD1 or AD2; and resilient element 128. In an example embodiment, element 126 is a ball. For the disconnect mode: element 124 is arranged to displace hub 104 in the axial direction AD1; resilient element 128 is arranged to displace element 126 radially outward; and element 126 is arranged to displace hub 102 in axial direction AD2. For the connect mode: element 124 is arranged to displace hub 104 in axial direction AD2; and hub 102 and hub 104 are arranged to displace element 126 radially inward.

In an example embodiment: hub 102 includes surface 130 sloping radially outward toward hub 104; and hub 104 includes surface 132 sloping radially outward toward hub 102. For the connect mode, surfaces 130 and 132 are arranged to displace element 126 radially inward. Thus, as hub 104 displaces in direction AD2 and element 122 urges hub 102 in direction AD1, surfaces 130 and 132 squeeze element 126 and force element 126 radially inward, decreasing axial gap 134 between plate 108 and plate 110 and axial gap 139 between hubs 102 and 104. In an example embodiment, in the connect mode, gap 134 disappears, for example, surfaces 136 and 138 of wedge plates 108 and 110, respectively, are in contact.

For the disconnect mode, element 126 is arranged to displace radially outward along surfaces 130 and 132. As hub 104 displaces in direction AD1, element 128 is able to displace element 126 radially outward into axial gap 139 between hubs 102 and 104. Once hub 104 has displaced a specified amount in direction AD1, for example, further displacement in direction AD1 is blocked by stop 140, hub 104 is blocked from displacing further in direction AD1. Since hub 104 is axially fixed, element 126 slides radially outward along surface 132, which pushes element 126 in direction AD2. Since element 126 is also in contact with surface 130, surface 130 and hub 102 also are displaced in direction AD2, increasing gap 139.

In an example embodiment, element 122 is a resilient element. In an example embodiment, element 124 is an actuator selected from the group consisting of a mechanical actuator, a hydraulic actuator, an electrical actuator and a pneumatic actuator.

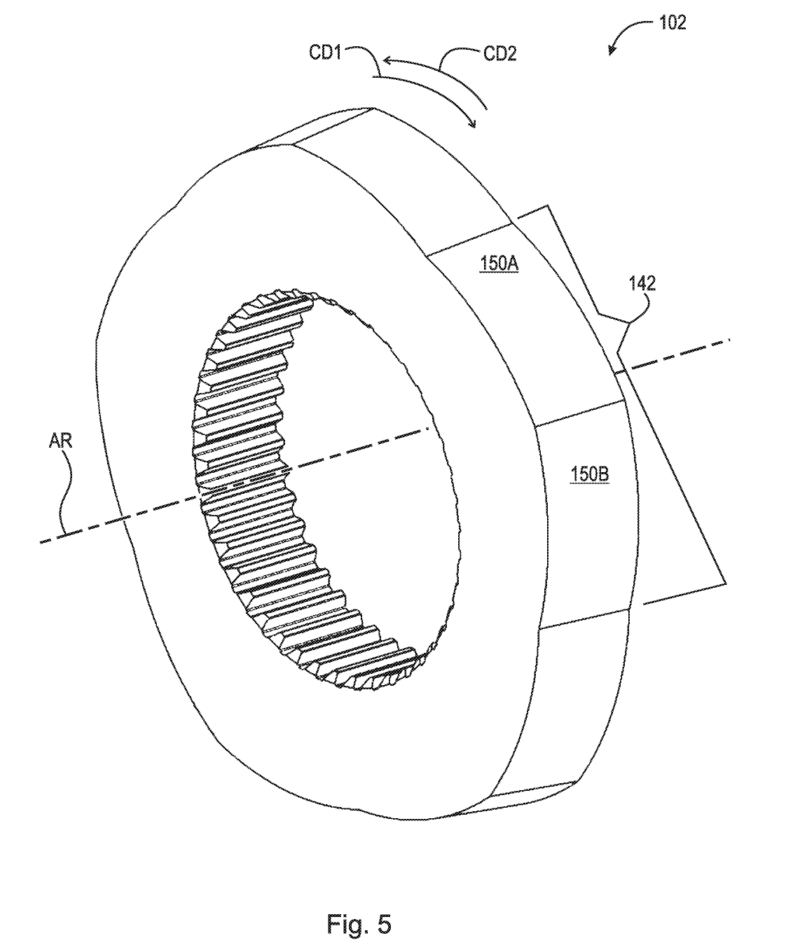

FIG. 5 is a cross-sectional view of hub 102, generally along line 5-5 in FIG. 2.

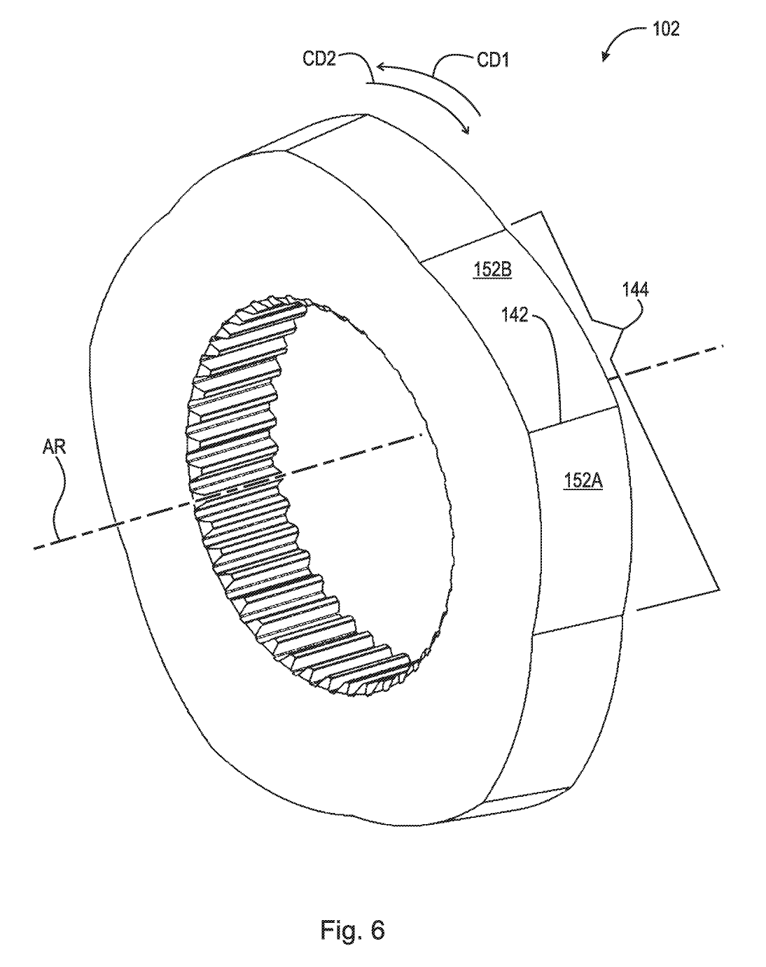

FIG. 6 is a cross-sectional view of hub 104, generally along line 6-6 in FIG. 2.

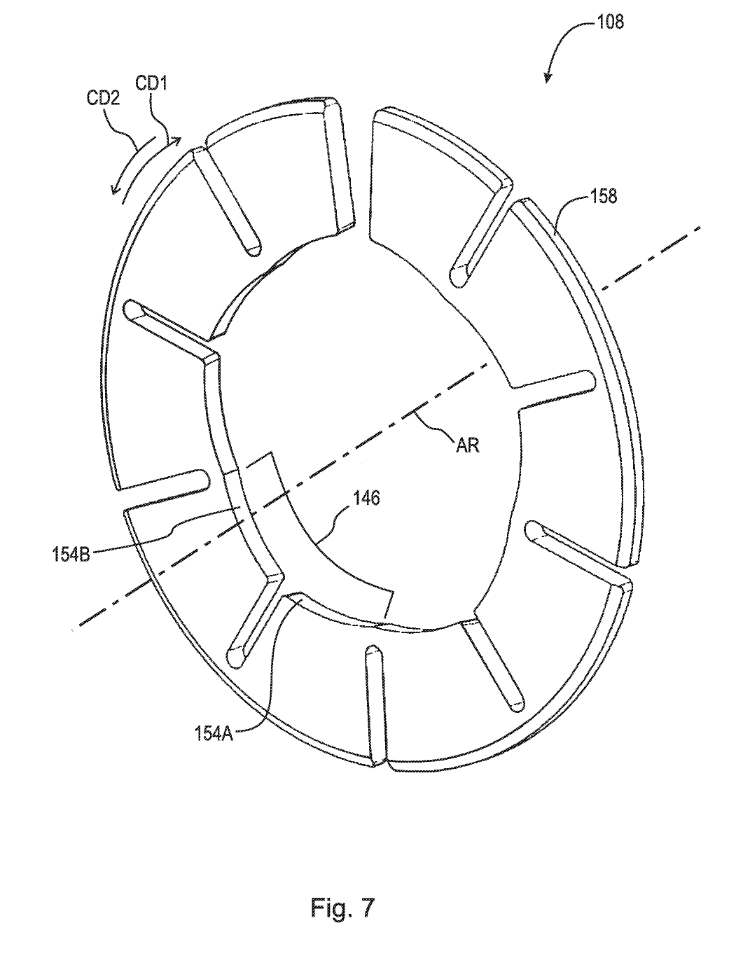

FIG. 7 is a front perspective view of wedge plate 108 shown in FIG. 2.

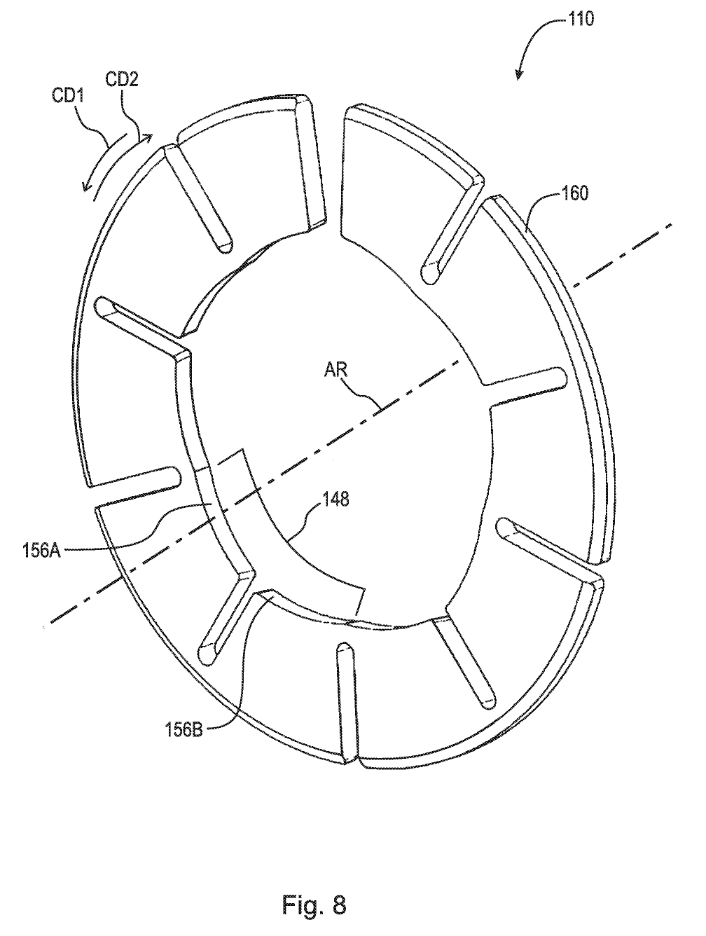

FIG. 8 is a back perspective view of wedge plate 110 shown in FIG. 2. The following should be viewed in light of FIGS. 2 through 8. In an example embodiment: hub 102 includes ramps, for example, ramp pairs 142; hub 104 includes ramps, for example ramp pairs 144; wedge plate 108 includes ramps, for example ramp pairs 146; and wedge plate 110 includes ramps, for example ramp pairs 148. Each ramp pair 142 includes ramp 150A extending radially outward in circumferential direction CD1 and ramp 150B extending radially outward in circumferential direction CD2. Each ramp pair 144 includes ramp 152A extending radially outward in circumferential direction CD1 and ramp 152B extending radially outward in circumferential direction CD2. Each ramp pair 146 includes ramp 154A extending radially outward in circumferential direction CD1 and ramp 154B extending radially outward in circumferential direction CD2. Each ramp pair 148 includes ramp 156A extending radially inward in circumferential direction CD1 and ramp 156B extending radially inward in circumferential direction CD2. Each ramp 150A is engaged with a respective ramp 154A. Each ramp 150B is engaged with a respective ramp 154B. Each ramp 152A is engaged with a respective ramp 156A. Each ramp 152B is engaged with a respective ramp 156B.

The following provides further detail regarding the structure and function of wedge clutch 100. Note that torque can be applied to either hubs 102 and 104 for transmission to ring 106 or to ring 106 for transmission to hubs 102 and 104. For example, to initiate the connected mode as shown in FIG. 2, torque is applied to hubs 102 and 104 in direction CD1 and hubs 102 and 104 are axially displaced toward each other. As hubs 102 and 104 axially displace toward each other, wedge plates 108 and 110 slide radially outwardly along surfaces 114 and 116, respectively. Outer circumferential surfaces 158 and 160 of plates 108 and 110, respectively, frictionally engage inner circumferential surface 162 of ring 106. Hubs 102 and 104 and wedge plates 108 and 110 are rotating relative to ring 106 in direction CD1. Therefore, the frictional engagement of plates 108 and 110 with ring 106 causes plates 108 and 110 to rotate with respect to hubs 102 and 104, respectively, causing ramps 150A and 152A to slide radially outwardly (slide up or climb) along ramps 154A and 156A, respectively, which in turn causes wedge plates 108 and 110 to expand radially outward. The radially outward expansion of wedge plates 108 and 110 causes wedge plates 108 and 110 to non-rotatably connect to ring 106 and to hubs 102 and 104.

As full torque is applied, the connection mode is completed as shown in FIG. 3. The application of the torque from hubs 102 and 104 to wedge plates 108 and 110, respectively, results in a radially inward compressive force that causes wedge plates 108 and 110 to slide down (radially inwardly) along surfaces 114 and 116, respectively, until sides 136 and 138 come into contact.

To initiate the disconnect mode shown in FIG. 4, hubs 102 and 104 are axially displaced away from each other and wedge plates 108 and 110 slide down surfaces 114 and 116, respectively, creating gaps 118 and 120. Since there is no contact between wedge plates 108 and 110 and ring 106, ring 106 and hubs 102 and 104 are able to rotate independently of each other. When the compressive force on wedge plates 108 and 110, associated with the connected mode, is released, wedge plates 108 and 110 slide down ramp pairs 142 and 144, respectively.

The discussion for torque applied in direction CD1 is applicable to torque applied in direction CD2. For example, to initiate the connected mode as shown in FIG. 2, torque is applied to hubs 102 and 104 in direction CD2 and hubs 102 and 104 are axially displaced toward each other. As hubs 102 and 104 axially displace toward each other, wedge plates 108 and 110 slide radially outwardly along surfaces 114 and 116, respectively. Outer circumferential surfaces 158 and 160 of plates 108 and 110, respectively, frictionally engage inner circumferential surface 162 of ring 106. Hubs 102 and 104 and wedge plates 108 and 110 are rotating relative to ring 106 in direction CD2. Therefore, the frictional engagement of plates 108 and 110 with ring 106 cause plates 108 and 110 to rotate with respect to hubs 102 and 104, respectively, causing ramps 150B and 152B to slide radially outwardly (slide up or climb) along ramps 154B and 156B, respectively, which in turn causes wedge plates 108 and 110 to expand radially outwardly. The radially outward expansion of wedge plates 108 and 110 causes wedge plates 108 and 110 to non-rotatably connect to ring 106 and to hubs 102 and 104. The discussion for the disconnect mode and torque in direction CD1 is applicable to the disconnect mode for torque in direction CD2.

Note that the above discussion regarding application of torque through hubs 102 and 104 is applicable to application of torque through ring 106.

In an example embodiment, element 122 is blocked from displacement in direction AD2 by snap ring 164. In an example embodiment, element 126 is contained in retainer 166, which limits radially outward displacement of element 126. Wedge plate 100 can be non-rotatably connected to shaft S, for example by splines 168 on hubs 102 and 104 interleaved with splines SP of shaft S.

Advantageously, wedge clutch 100 resolves the problem noted above of wedge plates deflecting under load. During full torque loading of wedge clutch 100, deflection forces F1 and F2 work to deflect wedge plates 108 and 110 in directions AD1 and AD2 respectively, for example, due to the slope of surfaces 114 and 116, respectively. However, as shown in FIG. 3, during full torque-loading of wedge clutch 100, wedge plates 108 and 110 come into contact and forces F1 and F2 neutralize each other. Thus, wedge plates 108 and 110 do not deflect and full contact is maintained between wedge plate 108 and hub 102 and ring 106 and between wedge plate 110 and hub 104 and ring 106.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A wedge clutch, comprising:
a first hub;
a second hub;
an outer ring located radially outward of the first and second hubs;
a first wedge plate radially disposed between the first hub and the outer ring;
a second wedge plate radially disposed between the second hub and the outer ring; and, a displacement assembly arranged to:
for a connect mode, axially displace the first and second hubs with respect to each other to non-rotatably connect the first and second hubs to the outer ring; and,
for a disconnect mode, axially displace the first and second hubs with respect to each other to enable rotation between the outer ring and the first and second hubs.

2. The wedge clutch of claim 1, wherein for the connect mode, the first and second wedge plates are arranged to contact each other.

3. The wedge clutch of claim 1, wherein the displacement assembly is arranged to:
for the connect mode, axially displace the first and second hubs toward each other; and,
for the disconnect mode, axially displace the first and second hubs away from each other.

4. The wedge clutch of claim 1, wherein:
the first hub includes a first surface sloping in a first axial direction and in contact with the first wedge plate; and,
the second hub includes a second surface sloping in a second axial direction, opposite the first axial direction, and in contact with the second wedge plate.

5. The wedge clutch of claim 4, wherein:
the first surface slopes radially inward toward the second hub; and,
the second surface slopes radially inward toward the first hub.

6. The wedge clutch of claim 1, wherein:
the first hub includes a first surface sloping in a first axial direction;
the second hub includes a second surface sloping in a second axial direction, opposite the first axial direction;
the first and second wedge plates are biased such that the first and second wedge plates are urged into contact with the first and second hubs, respectively; and,
for the disconnect mode:
the first and second surfaces are arranged to slide along the first and second wedge plates; and,
the first and second wedge plates are arranged to displace radially inward.

7. The wedge clutch of claim 1, wherein:
the first hub includes a first surface sloping in a first axial direction;
the second hub includes a second surface sloping in a second axial direction, opposite the first axial direction;
the first and second wedge plates are biased such that the first and second wedge plates are urged into contact with the first and second hubs, respectively; and,
for the connect mode:
the first and second surfaces are arranged to slide along the first and second wedge plates; and,
the first and second wedge plates are arranged to displace radially outward.

8. The wedge clutch of claim 1, wherein:
the displacement assembly includes:
a first element urging the first hub in a first axial direction;
a second element;
a third element disposed between the first and second hub in a first axial direction; and,
a first resilient element; and,
for the disconnect mode:
the second element is arranged to displace the second hub in the first axial direction;
the first resilient element is arranged to displace the third element radially outward; and,
the third element is arranged to displace the first hub in a second axial direction, opposite the first axial direction.

9. The wedge clutch of claim 8, wherein for the connect mode:
the second element is arranged to displace the second hub in the second axial direction; and,
the first and second hubs are arranged to displace the third element radially inward.

10. The wedge clutch of claim 8, wherein:
the first hub includes a first surface sloping radially outward toward the second hub;
the second hub includes a second surface sloping radially outward toward the first hub;
for the connect mode, the first and second surfaces are arranged to displace the third element radially inward; and,
for the disconnect mode, the third element is arranged to displace radially outward along the first and second surfaces.

11. The wedge clutch of claim 8, wherein:
the first element is a second resilient element; and,
the second element is an actuator selected from the group consisting of a mechanical actuator, a hydraulic actuator, an electrical actuator and a pneumatic actuator.

12. The wedge clutch of claim 1, wherein:
the first hub includes a first plurality of ramps;
the first wedge plate includes a second plurality of ramps engaged with the first plurality of ramps;
the second hub includes a third plurality of ramps;
the second wedge plate includes a fourth plurality of ramps engaged with the third plurality of ramps; and,
for the connect mode, the second and fourth pluralities of ramps are arranged to slide radially outwardly along the first and third pluralities of ramps, respectively, in a first circumferential direction or in a second circumferential direction, opposite the first circumferential direction.

13. A wedge clutch, comprising:
a first hub including a first surface sloping radially inward in a first axial direction;
a second hub including a second surface sloping radially inward in a second axial direction opposite the first axial direction;
an outer ring located radially outward of the first and second hubs;
a first wedge plate radially disposed between the first hub and the outer ring and engaged with the first surface;
a second wedge plate radially disposed between the second hub and the outer ring and engaged with the second surface; and,
a displacement assembly arranged to:
for a connect mode, axially displace the first and second hubs with respect to each other to non-rotatably connect the first and second hubs to the outer ring; and,
for a disconnect mode, axially displace the first and second hubs with respect to each other to enable rotation between the outer ring and the first and second hubs.

14. The wedge clutch of claim 13, wherein:
for the connect mode:
the displacement assembly is arranged to axially displace the first and second hubs in the first and second axial directions, respectively; and,
the first and second hubs are arranged to displace the first and second wedge plates, respectively, radially outward; and,
for the disconnect mode:
the displacement assembly is arranged to axially displace the first and second hubs in the second and first axial directions, respectively; and,
the first and second wedge plates are arranged to displace radially inward.

15. The wedge clutch of claim 13, wherein:
the displacement assembly includes:
a first element urging the first hub in the first axial direction;
a second element;
a ball disposed between the first and second hubs in the first axial direction; and,
a first resilient element urging the ball radially outward;
for the connect mode:
the second element is arranged to displace the second hub in the first axial direction; and,
the first and second hub are arranged to displace the ball radially inward; and,
for the disconnect mode, the first resilient element is arranged to displace the ball radially outward.

16. The wedge clutch of claim 13, wherein:
the displacement assembly includes:
a first element urging the first hub in the first axial direction;
a second element;
a ball disposed between the first and second hubs in the first axial direction; and,
a first resilient element urging the ball radially outward;
the first hub includes a third surface sloping radially outward toward the second hub;
the second hub includes a fourth surface sloping radially outward toward the first hub;
the third element is in contact with the third and fourth surfaces;
for the connect mode, the third and fourth surfaces are arranged to displace the ball radially inward; and,
for the disconnect mode, the first resilient element is arranged to displace the ball radially outward along the third and fourth surfaces.

17. The wedge clutch of claim 13, wherein:
the first hub includes a first plurality of ramps;
the first wedge plate includes a second plurality of ramps engaged with the first plurality of ramps;
the second hub includes a third plurality of ramps;
the second wedge plate includes a fourth plurality of ramps engaged with the third plurality of ramps; and,
for the connect mode, the second and fourth pluralities of ramps are arranged to slide radially outwardly along the first and third pluralities of ramps, respectively, in a first circumferential direction or in a second circumferential direction, opposite the first circumferential direction.

18. A wedge clutch, comprising:
a first hub;
a second hub;
an outer ring located radially outward of the first and second hubs;
a first wedge plate radially disposed between the first hub and the outer ring and in contact with the first hub;
a second wedge plate radially disposed between the second hub and the outer ring and in contact with the second hub; and,
a displacement assembly including:
a first resilient element urging the first hub in a first axial direction;
an actuator;
a ball axially located between the first and second hubs; and,
a second resilient element urging the ball radially outward, wherein:
for a connect mode:
the first resilient element is arranged to displace the first hub in the first axial direction;
the actuator is arranged to displace the second hub in a second axial direction opposite the first axial direction; and,
the first and second hubs are arranged to displace the first and second wedge plates, respectively, radially outward to non-rotatably connect the first and second hubs to the outer ring; and,
for a disconnect mode:
the actuator is arranged to displace the second hub in the first axial direction;
the second resilient element is arranged to displace the first hub in the second axial direction; and,
the first and second wedges are arranged to displace radially inward to enable rotation between the outer ring and the first and second hubs.

19. The wedge clutch of claim 18, wherein:
the first hub includes a first surface sloping radially inward in the first axial direction and in contact with the first wedge plate; and,
the second hub includes a second surface sloping radially inward in the second axial direction and in contact with the second wedge plate.

20. The wedge clutch of claim 18, wherein:
the first hub includes a first plurality of ramps;
the first wedge plate includes a second plurality of ramps engaged with the first plurality of ramps;
the second hub includes a third plurality of ramps;
the second wedge plate includes a fourth plurality of ramps engaged with the third plurality of ramps; and,
for the connect mode, the second and fourth pluralities of ramps are arranged to slide radially outwardly along the first and third pluralities of ramps, respectively, in a first circumferential direction or in a second circumferential direction, opposite the first circumferential direction.
